(19) United States
(12) Patent Application Publication
(10) Pub. No.: US 2006/0144775 A1
(43) Pub. Date: Jul. 6, 2006

(54) Rotary filter device for filtering liquids

(75) Inventors: Hans-Peter Feuerpeil, Schwabisch Gmund (DE); Dieter Blase, Mutlangen (DE); Hans Olapinski, Aichwald (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: AAFlOWSYSTEMS GMBH & CO.KG, Essingen (DE)

(21) Appl. No.: 10/532,463

(22) PCT Filed: Aug. 12, 2003
(86) PCT No.: PCT/EP03/08924

§ 371 Date: Feb. 10, 2006

(30) Foreign Application Priority Data
Aug. 22, 2002 (DE) 102 39 247.1

(51) Int. Cl. B01D 63/00

(52) U.S. Cl. 210/321.68

(57) ABSTRACT

The present invention relates to a device for filtering a medium. According to the present invention, such a device having the following features is provided: A device for filtering a medium; having at least one membrane disk; having at least one turbulence disk; the two disks being mounted so they are rotatable; the two disks being positioned as follows: their axes of rotation run essentially parallel to one another they overlap in a top view they are positioned close next to one another in the axial direction, so that the turbulence disk generates a turbulence in the region of the relevant lateral face of the membrane disk; the membrane disk being connected to a hollow shaft so that they rotate together; the hollow shaft being conductively connected to a cavity in the membrane disk; the two disks being able to be driven in the same rotational direction; the device is characterized in that the diameter of the membrane disk is sufficiently smaller than the diameter of the turbulence disk that the difference of the peripheral velocities of the two disks on the connection line between their axes of rotation is at least approximately equally large at every point in the overlap region.

The present invention relates to a device for filtering liquids. Such a device is described, for example, in DE 100 19 672 A1.

Devices of this type are used for transverse flow permeation of free-flowing media. They comprise at least two shafts, on each of which many disk-shaped membrane elements are positioned parallel to one another and at mutual intervals. The shafts are hollow and the membrane disks comprise ceramic material and are penetrated by radial channels. There is a conductive connection between the radial channels and the interior of the hollow shaft. The liquid to be filtered reaches the channels from the outside through the porous material of the membrane elements, and from there reaches the hollow shaft.

The shafts cited run parallel to one another, so that the membrane disks of two disk assemblies neighboring one another are also positioned parallel to one another. In this case, the shafts are positioned closely enough to one another that the disks of two disk assemblies engage in one another like teeth.

The disks do not have to have the cited construction of porous ceramic material. There are also applications in which a few disks are constructed as dummy disks. Manufacturing the disks from screen elements is also conceivable. Combinations of the types of construction cited are also conceivable, such as the pairing of screen elements and membrane elements. In the following, only “disks” will be referred to.

In the following, the combination of at least one membrane disk with at least one turbulence disk will be discussed. The membrane disk comprises a ceramic material which is porous. In addition, the disk has microscopic cavities in its interior. These cavities have a conductive connection to the interior of the hollow shaft which supports the membrane disk.

The turbulence disk is located on a separate shaft, which may also be hollow. In this case, it may be used to supply unfiltered medium.

The shafts cited having the disks seated thereon are typically positioned in a container. This container contains the liquid to be treated, which is to be passed through the membrane material and from which filtrate reaches the cavity of the hollow shaft and is drained off therefrom. The container is typically a closed pressurized container.

During filtration in a device of the type cited, the following main requirements are to be fulfilled: firstly, the filtrate quality is to be as high as possible. This means that the materials to be separated are to be separated as completely as possible from the medium to be filtered. In addition, however, the throughput, i.e., the quantity of medium filtered per unit of time, is to be as high as possible.

These two requirements oppose one another in practice. If the filtration quality is high, the throughput is automatically low.

A further requirement is the requirement for a long service life. In this case, service life is understood as the time span between two cleaning procedures of the membrane disk. In other words, this is the duration between two necessary cleaning procedures.

If one wishes to in crease the throughput at a given filtration quality, one could consider increasing the pressure in the pressurized vessel in order to press the greatest possible quantity of filtrate through the pores of the membrane. However, in many cases, in the filtration of gelatin solutions or beer, for example, this leads to a change of the filtrate quality and to a reduction of the flux. Therefore, in the event of too high a pressure differential between unfiltered material and permeate, only the opposite of what is desired is achieved.

The present invention is based on the object of designing a device of the type described at the beginning in such a way that the highest possible filtration quality is achieved at the highest possible throughput and with long service life, and also while operating the entire membrane area and allowing optimum and equal transmembrane pressure. “Transmembrane pressure” is the pressure differential which exists between unfiltered material on the front side of the filter medium in the flow direction and the filter disk, therefore after the passage through the filter medium.

This object is achieved by the features of claim 1.

The inventor started from the following considerations:

The inventor assumed disks—a membrane disk and a neighboring turbulence disk—which overlap in a top view and which additionally rotate in the same rotational direction.

If the disks have equally large diameters and rotate at the same speed, the relative velocity between the two disks is equally large at any arbitrary point of the overlap region, i.e., at any arbitrary distance from one axis of rotation and the other axis of rotation.

If the requirement exists for the most constant and low transmembrane pressure possible, the pressure increase PZ within the disk (from the inside to the outside), which is generated by centrifugal force, may not exceed a specific value. This means the membrane disk may not exceed a specific peripheral velocity. Otherwise, filter medium in the peripheral region of the membrane disk flows out of the disk back into the unfiltered material chamber.

The requirement for constant and simultaneously very high velocity differential between neighboring, overlapping disks at a low pressure increase pz within the membrane disk, which is generated by centrifugal force, may then only be fulfilled, however, if the membrane disk only rotates slowly and the turbulence disk rotates at a correspondingly higher velocity.

In a system comprising a membrane disk and a turbulence disk, the following requirements are to be fulfilled, for example:
ΔV=constant (on the connection line between the axis of rotation of a membrane disk and the axis of rotation of a turbulence disk)
ΔV=significantly larger than 5 m/s
p_{z}=<0.1

The membrane disk and the turbulence disk must have a specific ratio to one another in regard to their diameter and their speeds.

### EXAMPLE 1

| | |
|---|---|
| Membrane disk diameter = | 312 mm |
| Speed of the membrane disk = | 4.5 s⁻¹ |
| Vₘₐₓ of the membrane disk = | 3.92 m/s |
| Vₘᵢₙ of the membrane disk = | 1.57 m/s |
| p_{z} of the membrane disk = | 0.15 bar |
| Desired ΔV = | 15 m/s |

In the position Vₘᵢₙ and/or Vₘₐₓ of the membrane disk (in the particular opposite direction), the turbulence disk must have velocities which cause a supplementation to the target velocity differential (ΔV=15 m/s).

At a desired ΔV of 15 m/s—for example, with a membrane disk having a diameter of 312 mm—in position Vₘᵢₙ 15−1.57=13.43 m/s and in position Vₘₐₓ 15−3.92=11.08 m/s must be generated by the turbulence disk.

The maximum velocity on the turbulence disk is therefore 13.43 m/s. The lower velocity of the turbulence disk in the position Vₘₐₓ of the membrane disk (11.08 m/s) is located at Radiusₘₐₓ of the turbulence disk—(position Vₘₐₓ−position Vₘᵢₙ)=Radiusmax−(156 mm−62.5 mm)=Radiusmax−93,5 mm

with (Radiusmax−93.5 mm)/Radiusmax=11.08/13.43, it follows that:
Radiusₘₐₓ=534.34 mm

The speed of the turbulence disk must be selected so that a peripheral velocity of 13.43 m/s results for Vₘₐₓ.
n*2Πr=13.43 m/s, therefore
n=4 s⁻¹

Altered requirements in regard to the parameters

maximum p_{z}

desired differential velocity

membrane disk size

result in corresponding diameters and speeds for the turbulence disk.

When a “turbulence disk” is discussed here, this means that it is a disk which has the function of turbulence generation. It may comprise ceramic or even metal, etc. It may be smooth, nubby, perforated, etc. It may be positioned on a solid shaft or a hollow shaft and may additionally assume the function of supplying medium to be filtered or washing medium.

### EXAMPLE II

Membrane disk diameter=312 mm

p_{z}=0.15 bar

Speed of the membrane disk=4.5 rpm

Vₘₐₓ of the membrane disk=3.92 m/s

| | Diameter of the | Speed of the |
|---|---|---|
| Differential velocity | dummy disk | dummy disk |
| m/s | m | rpm |
| 8 | 0.512 | 4 |
| 10 | 0.671 | 4 |
| 15 | 1.07 | 4 |
| 20 | 1.466 | 4 |

### EXAMPLE III

Membrane disk diameter=90 mm

p_{z}=0.15 bar

Speed of the membrane disk=13.55 rpm

Vₘₐₓ of the membrane disk=3.92 m/s

| | Diameter of the | Speed of the |
|---|---|---|
| Differential velocity | dummy disk | dummy disk |
| m/s | m | rpm |
| 8 | 0.272 | 7 |
| 10 | 0.361 | 7 |
| 15 | 0.587 | 7 |
| 20 | 0.812 | 7 |

Examples of Pressure Ratios Because of Centrifugal Forces in Membrane Disks Having Different Diameters

The following overviews show the relationship between Vₘᵢₙ, Vₘₐₓ, ΔV, p_{zmax}, and the speed of the membrane disks (at identical speed and identical rotational direction).

### EXAMPLE 1

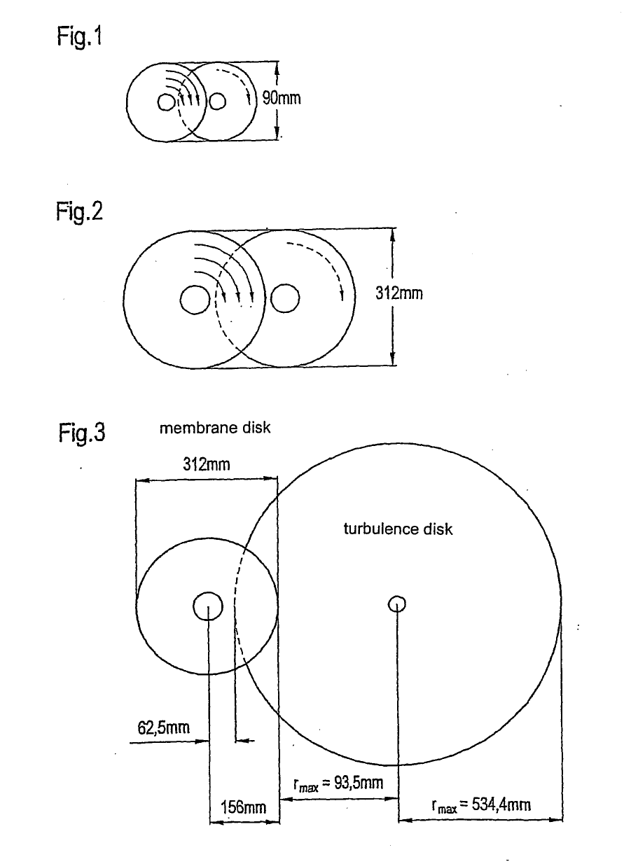

Both membrane disks have diameter of 90 mm. Reference is made to FIG. 1.

| N (s⁻¹) | Vₘᵢₙ^{(ms-1)} | Vₘₐₓ^{(ms-1)} | ΔV^{(ms-1)} | p_{z} bar ≈ |
|---|---|---|---|---|
| 2 | 0.28 | 0.56 | 0.84 | 0.004 |
| 5 | 0.71 | 1.41 | 2.12 | 0.018 |
| 10 | 1.41 | 2.83 | 4.24 | 0.08 |
| 15 | 2.12 | 4.24 | 6.36 | 0.18 |
| 20 | 2.83 | 5.65 | 8.48 | 0.35 |
| 30 | 4.24 | 8.48 | 12.72 | 0.85 |

### EXAMPLE 2

Both membrane disks have a disk diameter of 312 mm. Reference is made to FIG. 2.

| n (s⁻¹) | Vₘᵢₙ^{(ms-1)} | Vₘₐₓ^{(ms-1)} | ΔV^{(ms-1)} | p_{z} bar ≈ |
|---|---|---|---|---|
| 1 | 0.393 | 0.98 | 1.37 | 0.01 |
| 2 | 0.785 | 1.96 | 2.75 | 0.04 |
| 4 | 1.571 | 3.92 | 5.49 | 0.15 |
| 6 | 2.36 | 5.88 | 8.24 | 0.35 |
| 8 | 3.14 | 7.84 | 10.98 | 0.63 |
| 12 | 4.72 | 11.76 | 16.48 | 1.40 |

p_{z} is only a function of the peripheral velocity of the membrane disk. In the case of the overlapping disks having identical rotational direction and identical speed, p_{z} is only a function of ΔV.

For filtration, this means that at only low, permissible transmembrane pressure of, for example, 0.4 bar, the pressure differential within the disk is not to exceed a significantly lower absolute value, such as 0.15 bar. Therefore, ΔV may assume a value of at most 5.49 m/s.

Higher velocities, which would be desirable for higher turbulence and better filtration performance, are therefore not permissible.

The requirements for constant velocity differential between the disks, and higher velocity differential at low p_{z} within the membrane disk, may be fulfilled if the membrane disk only revolves slowly, at less than 5 m/s, for example, and the corresponding higher velocity is assumed by a turbulence disk.

In order to fulfill all requirements in a system of membrane disk and turbulence disk, for example, specifically:

ΔV constant

ΔV>>5 m/s

p_{z}<0.15 (in the membrane disk),

the turbulence disk must have a specific ratio to the membrane disk in regard to diameter and speed.

### EXAMPLE

| | |
|---|---|
| Membrane disk diameter = | 312 mm |
| Speed of the membrane disk = | 4 s−1 |
| Vₘₐₓ of the membrane disk = | 3.92 m/s |
| Vₘᵢₙ of the membrane disk = | 1.57 m/s |
| p_{z} of the membrane disk = | 0.15 bar |
| Desired ΔV = | 15 m/s |

In the position Vₘᵢₙ and/or Vₘₐₓ of the membrane disk (in the particular opposite direction), the turbulence disk must have velocities which cause a supplementation to the target velocity (ΔV=15 m/s).

At a target ΔV of 15 m/s, in position Vₘᵢₙ 15−1.57=13.43 m/s and in position Vₘₐₓ 15−3.92=11.08 m/s must be generated in the opposite direction.

Determining the “correct” diameter of the turbulence disk:

The maximum velocity on the turbulence disk is 13.43 m/s. The lower velocity of the turbulence disk in the position Vₘₐₓ of the membrane disk is 11.08 m/s. It is located at

$${Radius}_{max} - ( position {V}_{max} - position {V}_{min} ) = {Radius}_{max} - ( 156 mm - 62 , 5 mm )$$

therefore at=Radiusₘₐₓ−93.5 mm

with (Radiusₘₐₓ−93.5 mm)/Radiusₘₐₓ=11.08/13.43

| | |
|---|---|
| (Radiusₘₐₓ − 93.5 mm) 13.43 = | 11.08 Vₘₐₓ |
| 13.43Radiusₘₐₓ − 1255.7 mm = | 11.08 Vₘₐₓ |
| 2.35Radiusₘₐₓ = | 1255.7 mm |
| Vₘₐₓ [sic: Radiusₘₐₓ] = | 534.34 mm |

Reference is made to FIG. 3.

The speed for the turbulence disk must be selected so that a peripheral velocity of 13.43 m/s results for Vₘₐₓ.

$$\begin{matrix}n * 2 Π {V}_{max} = 13.43 m \text{/} s \\ = ( 13.43 m \text{/} s ) / ( 0.53434 m * 2 * Π ) \\ = 4.0 {s}^{- 1}\end{matrix}$$

Altered requirements in regard to the parameters

maximum p_{z}

desired differential velocity

membrane disk size

result in corresponding diameters and speeds for the turbulence disk.

Membrane disk diameter 312 mm

p_{z}=0.15 bar

speed of the membrane disk=4 s⁻¹

Vₘₐₓ of the membrane disk=3.92 m/s

| | Diameter of the | Speed of the |
|---|---|---|
| Differential velocity | turbulence disk | turbulence disk |
| m/s | m | s⁻¹ |
| 8 | 0.512 | 4 |
| 10 | 0.671 | 4 |
| 15 | 1.07 | 4 |
| 20 | 1.466 | 4 |

Membrane disk diameter 90 mm

p_{z}=0.15 bar

Speed of the membrane disk=13.5 s⁻¹

Vₘₐₓ of the membrane disk=3.92 m/s

| Differential velocity | Diameter of the | Speed of the |
|---|---|---|
| membrane-turbulence disk | turbulence disk | turbulence disk |
| m/s | m | s⁻¹ |
| 8 | 0.272 | 7 |
| 10 | 0.361 | 7 |
| 15 | 0.587 | 7 |
| 20 | 0.812 | 7 |

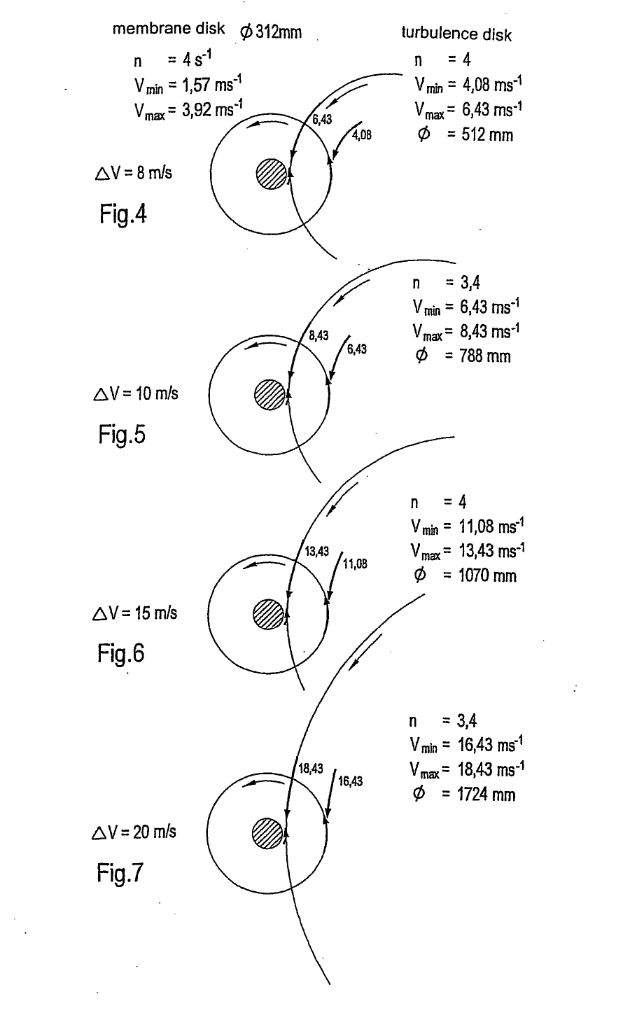

FIGS. 4 through 7 show further exemplary embodiments. Two disks are illustrated in each figure. The disk shown on the left is a membrane disk. It has an identical diameter in all four cases, specifically 312 mm.

The disk shown on the right is a turbulence disk. It has different sizes in the four FIGS. 4, 5, 6, 7 cited; its diameter is 512, 788, 1070, and 1724 mm.

The desired differential velocities ΔV are listed on the left next to the membrane disk: 8, 10, 15, 20 m/s.

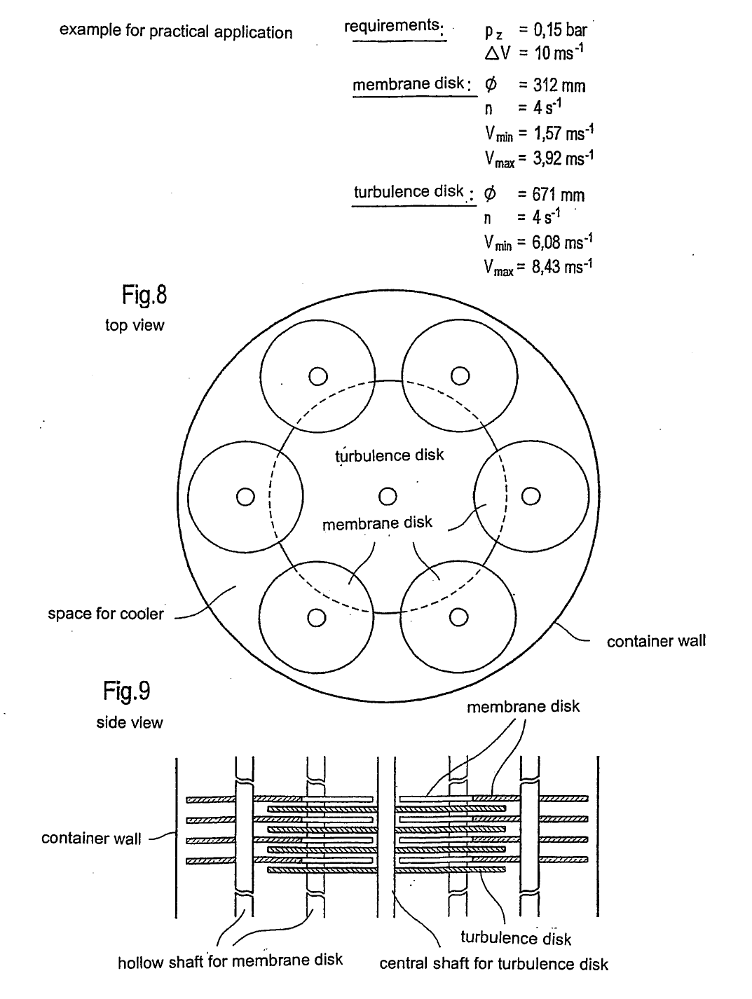

FIGS. 8 and 9 illustrate a further embodiment. In this case, six membrane disks are grouped around a turbulence disk—always with overlap, as is shown clearly. FIG. 8 shows the device in a top view, and FIG. 9 shows the device in a side view. The disks cited are located in a container whose interior is under pressure.

1-3. (canceled)

4. A device for filtering a medium, the device comprising:
at least one membrane disk and at least one turbulence disk, wherein said at least one membrane disk and said at least one turbulence disk are rotationally mounted,
wherein said at least one membrane disk and said at least one turbulence disk are positioned in such a manner that a rotation axis of each of said at least one membrane disk and said at least one turbulence disk are essentially parallel to one another, said at least one membrane disk and said at least one turbulence disk overlapping when viewed from above,
wherein said at least one membrane disk and said at least one turbulence disk are placed in spaced relation from one another in an axial direction so that said at least one turbulence disk produces a turbulence in a region, said region being a relevant affected lateral face of said at least one membrane disk,
wherein said at least one membrane disk is connected to a hollow shaft, said at least one membrane disk being connected in a rotationally fixed manner so said at least one membrane disk and said hollow shaft rotate together,
wherein said hollow shaft is conductively connected to a cavity, said cavity being in said at least one membrane disk,
wherein said at least one membrane disk and said at least one turbulence disk are driven in substantially a same direction of rotation,
wherein said at least one membrane disk has a diameter less than a second turbulent disk diameter, and
wherein the device has a difference in a peripheral velocity on a connecting line, said connecting line between each rotation axis of said at least one membrane disk and said at least one turbulence disk, said difference between said at least one membrane disk and said at least one turbulence disk being at least about equally large at every point in said region.

5. The device of claim 4, further comprising a plurality membrane disks forming a species and a plurality of turbulence disks forming a second species, wherein said species and said second species are positioned so that at least one membrane disk of said species and at least one turbulence disk of said second species engages an intermediate space.

6. The device of claim 4, where said at least one turbulence disk is connected to a second hollow shaft having a second cavity, wherein said least one turbulence disk and said second hollow shaft rotate together, and wherein said second hollow shaft has said cavity conductively connected to said second cavity.
